(19) United States
(12) Patent Application Publication
(10) Pub. No.: US 2016/0064109 A1
(43) Pub. Date: Mar. 3, 2016

(54) X-RAY IMAGING APPARATUS

(71) Applicant: CANON KABUSHIKI KAISHA, Tokyo (JP)

(72) Inventor: Kimiaki Yamaguchi, Tokyo (JP)

(21) Appl. No.: 14/835,830

(22) Filed: Aug. 26, 2015

(30) Foreign Application Priority Data
Sep. 1, 2014 (JP) 2014-177490

(51) Int. Cl. G21K 1/06; G01N 23/20

(52) U.S. Cl. CPC G21K 1/067; G01N 23/20075

(57) ABSTRACT

An X-ray imaging apparatus includes: a plurality of gratings; a detector which detects X-rays that have been emitted from an X-ray generator and have been transmitted through the plurality of gratings; a first support member which supports the plurality of gratings and the detector; a second support member which supports the X-ray generator and the first support member; and a first vibration-proof member which is disposed between the first support member and the second support member. A natural frequency of the first vibration-proof member in respect of at least vibration in a direction perpendicular to the optical axis of the X-rays is lower than 2^{-1/2} times the frequency of vibration generated by the X-ray generator.

### BACKGROUND OF THE INVENTION

1. Field of the Invention

The present invention relates to an X-ray imaging apparatus using X-rays.

2. Description of the Related Art

In recent years, investigation has been carried out into an imaging method known as “phase-contrast X-ray imaging”, in which contrast is generated on the basis of changes in the phase of X-rays upon being transmitted through an object. One phase-contrast X-ray imaging method of this kind is the imaging method called “X-ray Talbot interferometry” disclosed in U.S. Pat. No. 7,180,979, which uses Talbot interference.

A brief explanation of Talbot interferometry is given here. In Talbot interferometry, it is common to use an X-ray Talbot interferometer provided with a diffraction grating, a shield grating (absorption grating), and a detector for detecting X-rays from the shield grating. When X-rays which have high spatial coherence are input to the diffraction grating, an interference pattern (self-image) having periodic brightness/darkness is formed at a specific position (“Talbot effect”). The pitch of the self-image when using X-rays is approximately several μm. When a self-image is acquired directly using a general two-dimensional X-ray detector, the imaging area size is approximately several mm. In order to ensure a broad imaging area, a portion of the self-image is shielded by the shielding grating to generate a moire fringe having a pitch equal to or greater than the pixel size, and the change in the self-image is acquired by a detector having a large surface area. When an object is positioned between the X-ray source and the detector, the X-rays from the X-ray source are subjected to refraction, absorption and scattering by the object. Therefore, the self-image changes, and it is possible to obtain information about the refraction, absorption and scattering of the object, from the changes in the intensity and position of the moire fringe at the detector.

The angle of refraction of the X-rays when transmitted through the object is a very small angle of several μrad. An X-ray Talbot interferometer generally uses a diffraction grating having a pitch of several μm, in order to observe a very slight amount of refraction. Due to these circumstances, if there is even the slightest deviation in the relative positions of the diffraction grating, the shield grating and the detector, due to the application of forces or vibrations, etc. to the gratings, then there is a decline in the contrast of the moire fringe detected by the detector.

As a countermeasure for reducing vibration, in Japanese Patent Application laid-open Publication No. 2008-200359, a holding structure which holds a diffraction grating and a shield grating, and an object stage, are composed as separate bodies, and furthermore, the holding structure is held via shock-absorbing material on a support member which supports the entire imaging apparatus.

By forming the holding structure for the diffraction grating and the shield grating, and the object stage, as separate bodies as in Japanese Patent Application laid-open Publication No. 2008-200359, it can be expected that vibration of the object and vibration of the peripheral environment of the apparatus installation will not be transmitted readily to the diffraction grating and the shield grating. However, not only is the vibration generated by the X-ray source transmitted to the gratings, but there is also a risk of decline in the contrast of the moire fringe when there is deviation in the relative positions of the detector and the gratings.

### SUMMARY OF THE INVENTION

The present invention provides an X-ray imaging apparatus, comprising: a plurality of gratings; a detector which detects X-rays that have been emitted from an X-ray generator and have been transmitted through the plurality of gratings; a first support member which supports the plurality of gratings and the detector; a second support member which supports the X-ray generator and the first support member; and a first vibration-proof member which is disposed between the first support member and the second support member, wherein a natural frequency of the first vibration-proof member in respect of at least vibration in a direction perpendicular to the optical axis of the X-rays is lower than 2^{-1/2} times the frequency of vibration generated by the X-ray generator.

According to the present invention, it is possible to provide an X-ray imaging apparatus that enables the capture of X-ray images using a smaller X-ray dose, by adequately suppressing deviation in the relative positions of the gratings and the detector, even if vibration occurs.

Further features of the present invention will become apparent from the following description of exemplary embodiments with reference to the attached drawings.

### BRIEF DESCRIPTION OF THE DRAWINGS

FIG. 1 is a diagram showing an example of the configuration of an X-ray imaging apparatus;

FIG. 2A is a schematic drawing of a one-dimensional grating;

FIG. 2B is a schematic drawing of a two-dimensional grating;

FIG. 3 is a diagram showing an amount of decline in the contrast of a moire fringe with respect to vibration in a second grating;

FIGS. 4A and 4B are diagrams showing the directions of vibration of the gratings and the detector;

FIG. 5 is a diagram showing one example of a vibration transmission factor when using natural rubber and an air spring;

FIG. 6 is a diagram showing an example of the configuration of an X-ray imaging apparatus;

FIGS. 7A and 7B are diagrams showing an example of the arrangement of a first vibration-proof member;

FIG. 8 is a diagram showing an example of the configuration of an X-ray imaging apparatus;

FIG. 9 is a diagram showing an example of the configuration of an X-ray imaging apparatus;

FIG. 10 is a diagram showing an example of the configuration of an X-ray imaging apparatus;

FIG. 11 is a diagram showing an example of the configuration of an X-ray imaging apparatus; and

FIG. 12 is a diagram showing an example of the configuration of an X-ray imaging apparatus.

### DESCRIPTION OF THE EMBODIMENTS

Below, a desirable embodiment of the present invention is described on the basis of the accompanying drawings. In the drawings, the same members are labelled with the same reference numerals and duplicated description thereof is omitted here.

In the present embodiment, an X-ray imaging apparatus which carries out Talbot interferometry using X-rays as light will be described. As described above, in a Talbot interferometer, if there is even the slightest deviation in the relative positions of the diffraction grating, the shield grating and the detector, due to the application of forces or vibrations, etc. to the gratings, then there is a decline in the contrast of the moire fringe detected by the detector. For example, when simple vibration of 10% of the pitch occurs in a diffraction grating having a pitch of 4 μm, the contrast of the moire fringe declines by 10%. When a similar calculation was made for all gratings and detectors, the final contrast of the moire fringe declined by approximately 30% to 40%. Furthermore, in order to obtain a specific image quality, due to the trade-off that exists between the contrast of the moire fringe and the X-ray dose, a decline in the contrast of the moire fringe leads to increase in the radiation exposure dose. Therefore, even when vibration occurs, the X-ray imaging apparatus of the present embodiment is able to capture X-ray images using a smaller X-ray dose, by suppressing deviation in the relative positions of the gratings and the detector.

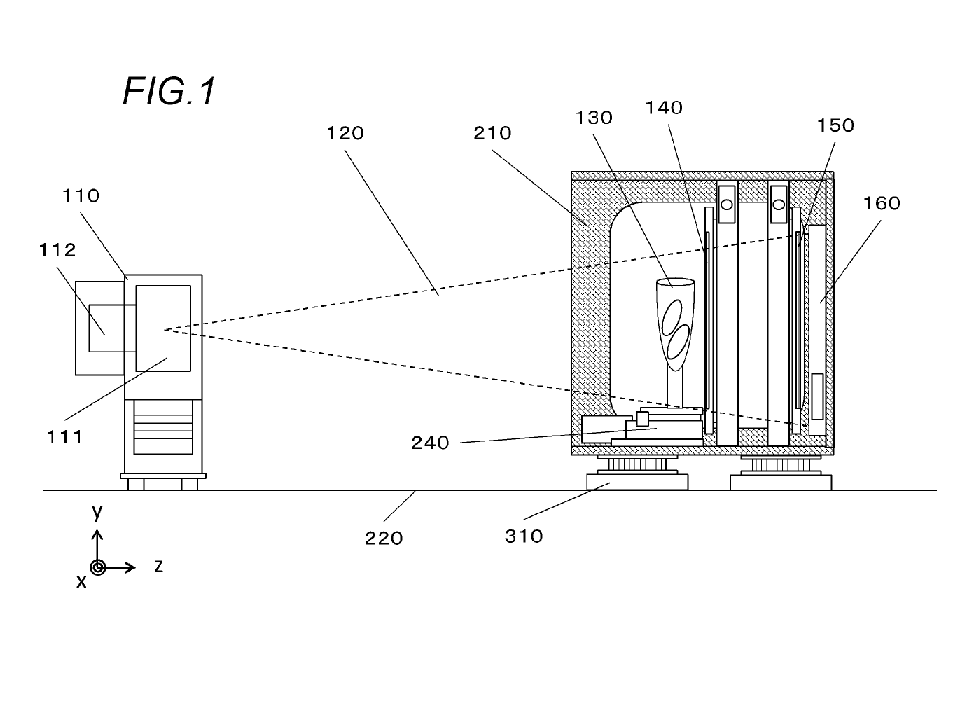

FIG. 1 is a schematic drawing illustrating the configuration of an X-ray imaging apparatus according to the present embodiment. The X-ray imaging apparatus shown in FIG. 1 is provided with: an X-ray generator 110 which generates X-rays, a first grating 140, a second grating 150, a detector 160 which detects X-rays, and a first support member 210 which supports the first grating 140, the second grating 150 and the detector 160. Moreover, a stage 240 on which the object 130 is placed is installed on the first support member 210. Moreover, the X-ray imaging apparatus is also provided with a second support member 220 which supports the X-ray generator 110 and the first support member 210, and a first vibration-proof member 310 which is disposed between the first support member 210 and the second support member 220.

The first grating 140 and the second grating 150 are a plurality of gratings which constitute a Talbot interferometer. The first grating 140 and the second grating 150 are also respectively called a beam splitter grating and an analyzer grating. The first grating 140 is a diffraction grating for forming a periodic interference pattern (called a “self-image”) by diffracting X-rays. The first grating 140 may be a phase-type diffraction grating (phase grating) which periodically modifies the phase of the X-rays, or an amplitude-type diffraction grating (absorption grating) which periodically modifies the amplitude of the X-rays, but a phase grating is commonly used due to having little X-ray loss. The second grating 150 is a grating for forming a moire fringe with the interference pattern formed by the first grating 140. A shield grating in which an X-ray transmitting section and an X-ray shielding section are arranged, is commonly used for the second grating 150.

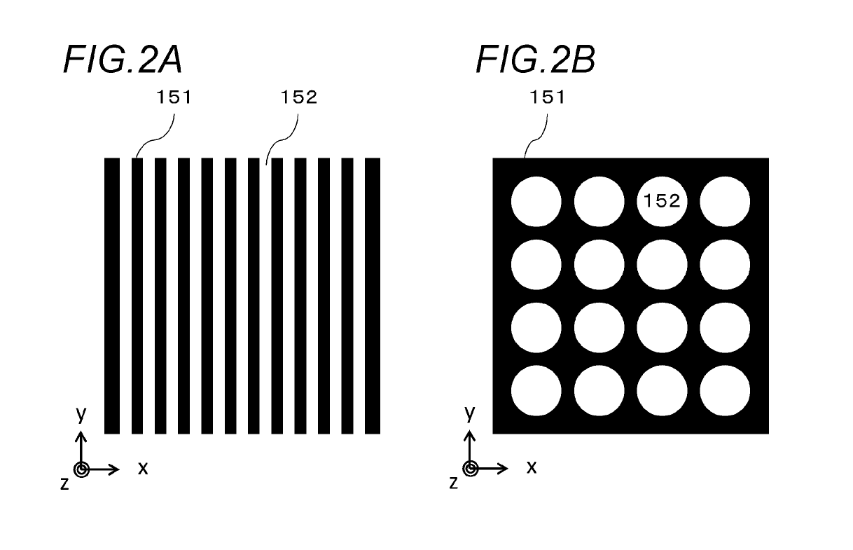

The first grating 140 and the second grating 150 may be a one-dimensional grating or a two-dimensional grating. In the case of a one-dimensional grating, as shown in FIG. 2A, the direction in which the period of the pattern is formed, is defined as the x direction, the direction in which the period of the pattern is not formed, is defined as the y direction, and the direction in which the X-rays 120 are transmitted (the direction parallel to the optical axis of the X-rays) is defined as the z direction. Furthermore, in the case of a two-dimensional grating, as shown in FIG. 2B, the directions in which the periods of the patterns are formed are defined as the x direction and the y direction, and the direction in which the X-rays 120 are transmitted, is defined as the z direction. In other words, the planar directions (x direction, y direction) of the first grating 140 and the second grating 150 are orthogonal directions with respect to the optical axis.

The X-ray imaging apparatus according to the present embodiment is provided with an X-ray generator 110 as a light source. For the X-ray generator 110, it is possible to use an X-ray generator 110 which emits white X-rays, or an X-ray generator 110 which emits characteristic X-rays.

Upon being transmitted through the object 130, the wave front of the X-rays 120 emitted from the X-ray generator 110 changes depending on the refractive index and the shape of the object 130. In FIG. 1, the object 130 is arranged between the X-ray generator 110 and the first grating 140, but the object 130 may also be arranged between the first grating 140 and the second grating 150.

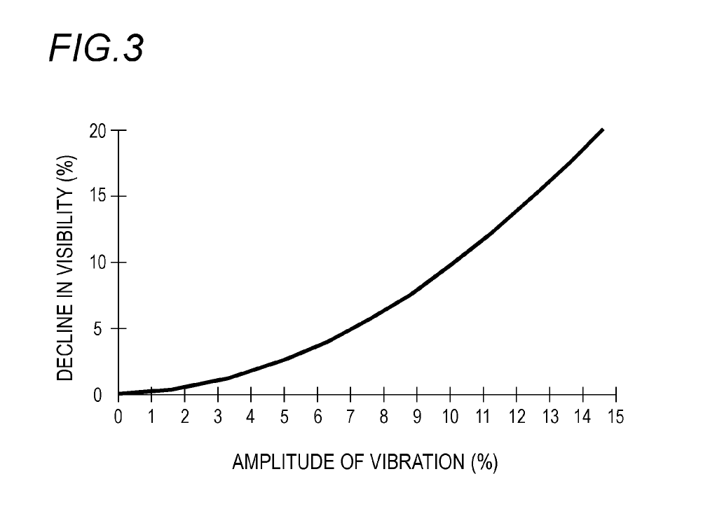

When the contrast of the moire fringe declines during measurement of the object 130, then the accuracy of the analysis of intensity change in the moire fringe declines, even at the same noise level, and therefore it is difficult to acquire refraction information for the object 130. In FIG. 3, the horizontal axis plots the ratio of the vibration with respect to the pitch of the second grating 150, and the vertical axis plots the amount of decrease in the contrast (visibility) of the moire fringe. The second grating 150 is a two-dimensional well-type grating such as that shown in FIG. 2B, in which the shape of the openings 152 is cylindrical, the X-ray transmissivity of the openings 152 is 100%, and the X-ray transmissivity of the shield section 151 is 0%. Furthermore, the vibration is simple vibration in the x direction. Furthermore, it is assumed that the second grating 150 does not vibrate in the y direction and the z direction, and that the first grating 140 and the detector 160 do not vibrate. From FIG. 3, if the second grating 150 vibrates simply in the x direction at an amplitude of 10% of the grating pitch, then the contrast of the moire fringe in the x direction declines by approximately 10%. When a similar calculation is carried out for the first grating 140, the contrast of the moire fringe is predicted to decline by approximately 20%. In order to improve the measurement accuracy in respect of the decline in contrast of the moire fringe, the X-ray dose must be increased. However, an increase in the X-ray dose is not desirable since this raises the radiation exposure dose of the object 130. Therefore, in order to obtain a clear X-ray image with a small X-ray dose, it is important to suppress vibration of the gratings.

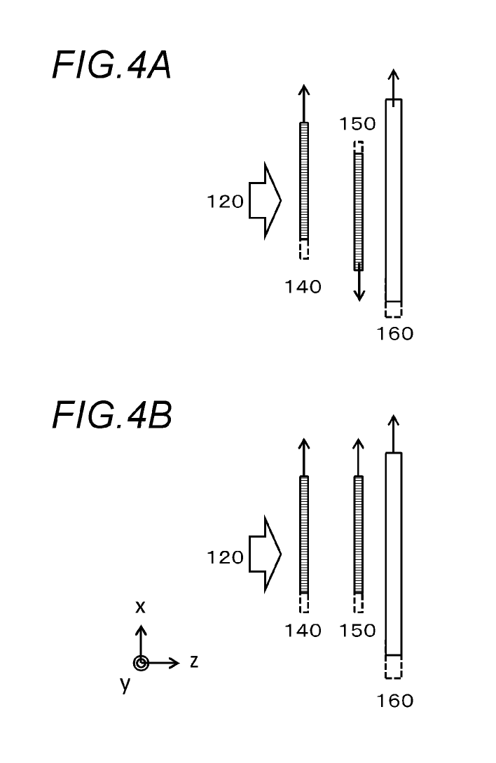

Furthermore, when the gratings 140, 150 and the detector 160 vibrate in a disparate fashion as shown in FIG. 4A, then there is marked decline in the contrast of the moire fringe. On the other hand, when the gratings 140, 150 and the detector 160 vibrate with the same period and in the same direction, as shown in FIG. 4B, then the contrast in the moire fringe does not decline. The reason for this is that the cause of decline in the contrast of the moire pattern is change in the positional relationship between the gratings 140, 150 and the detector 160. If the positional relationship of the gratings 140, 150 and the detector 160 is kept uniform at all times, then the contrast of the moire fringe does not decline, whatever vibration may occur. Therefore, the X-ray imaging apparatus of the present embodiment employs a vibration-proofing structure which maintains the relative positions of the gratings 140, 150 and the detector 160, and reduces vibration occurring in the gratings 140, 150. More specifically, by fixing the first grating 140, the second grating 150 and the detector 160 to the first support member 210, then even if the first support member 210 vibrates, the first grating 140, the second grating 150 and the detector 160 will vibrate in the same direction and with the same period (although not completely). Moreover, by installing a first vibration-proof member 310, the vibration of the first support member 210 itself is suppressed.

The following three main types of vibration source can be envisaged in a Talbot interference imaging apparatus using X-rays.

(1) X-ray generator: An electronically excited high-output X-ray generator often has a rotating anticathode in order to cool the anticathode which generates heat due to the impact of electrons. In this case, vibration (50 Hz or higher) occurs in accordance with the speed of revolution.
(2) Installation environment: Vibration occurs at various frequencies from 3 to 20 Hz, depending on the presence/absence of trunk roads, the building structure and the installation location.
(3) Object: A tissue section, and the like, is not a source of vibrations, but a living object often vibrates at a frequency of 2 to 8 Hz.

A description is now given of a method for suppressing the transmission, to the gratings 140, 150 and the detector 160, of the vibration that occurs due to “(1) the X-ray generator” and “(2) the installation environment”. The first vibration-proof member 310 which is disposed between the first support member 210 and the second support member 220 is a member for suppressing the transmission, to the gratings 140, 150 and the detector 160, of vibration that is produced by the X-ray generator 110 or the installation environment.

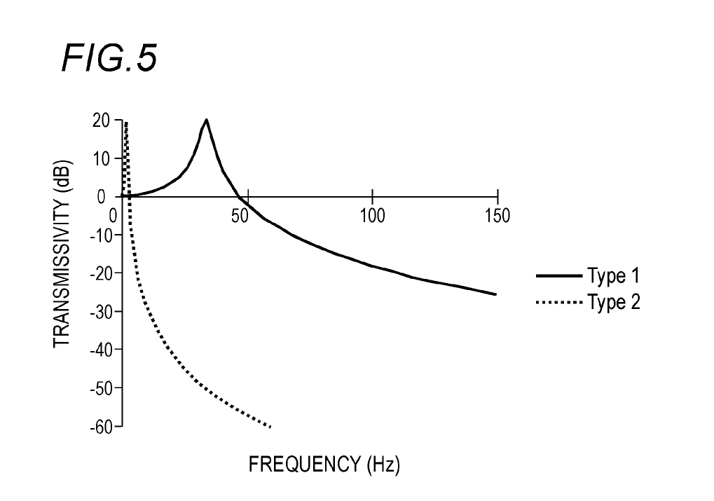

The vibration characteristics (natural frequency) required of the vibration-proof member, and the transmission of vibration, are now described with reference to FIG. 5. The transmission factor (Tr) of the vibration-proof member with respect to the frequency (f) of vibration is indicated in Formula (1).

$$\begin{matrix}Tr = 20 {log}_{10} \vert \frac{1}{1 - {( \frac{f}{{f}_{0}} )}^{2}} \vert & ( 1 ) \\ {f}_{0} = \frac{1}{2 π} \sqrt{K / m} & ( 2 )\end{matrix}$$

Here, the natural frequency of the vibration-proof member is f₀, the spring constant is K and the load applied to the vibration-proof member is m.

FIG. 5 shows the characteristics of two types of vibration-proof member (Type 1 and Type 2). The horizontal axis is the frequency (Hz) of the vibration input to the vibration-proof member and the vertical axis is the transmission factor (dB) of the vibration. The graph shows the respective vibration frequencies and vibration transmission factors when a load of 70 N is applied to natural rubber in the case of Type 1, and when a load of 70 N is applied to an air spring in the case of Type 2.

In the case of the vibration-proof member of Type 1, there is a vibration-proofing effect in respect of vibrations above approximately 47 Hz (Tr<0), and at a vibration frequency higher than 100 Hz, for example, it is possible to suppress 90% or more of the vibration. Therefore, it can be seen that a vibration-proofing effect of a certain level can be expected in relation to vibrations produced by the X-ray generator 110 (50 Hz or higher). However, the vibration-proof member of Type 1 does not have a vibration-proofing effect in relation to vibrations of approximately 47 Hz and lower (Tr≧0). This is not a problem in cases where the installation environment of the X-ray imaging apparatus is not liable to be affected by external vibrations, but in an installation environment where vibrations at or below approximately 47 Hz occur, the vibration-proof member of Type 1 is not suitable.

On the other hand, in the case of the vibration-proof member of Type 2, it is possible to achieve sufficient suppression of vibrations at or above approximately 3 Hz. Therefore, if the input of vibrations between approximately 3 Hz and 50 Hz is expected, then it is effective to use a vibration-proof member of Type 2.

In this way, it is important to set the vibration characteristics of the vibration-proof member appropriately, in accordance with the expected frequency of the vibrations. For example, in the apparatus configuration in FIG. 1, the vibrations from the X-ray generator 110, which is the vibration source, are suppressed by the first vibration-proof member 310. If the frequency of the vibration that is to be suppressed (the vibration produced by the X-ray generator 110 in the present example) is f₁, then from Formula (1), the condition for making the transmission factor Tr smaller than 0 is

$${f}_{0} < \frac{1}{\sqrt{2}} {f}_{1} \qquad ( 3 )$$

In other words, the natural frequency f₀ of the first vibration-proof member 310 should be lower than 2^{-1/2} times the frequency f₁ of the vibration that is to be suppressed. By using the first vibration-proof member 310 which has characteristics of this kind, the transmission of vibration produced by the X-ray generator 110 to the first support member 210 is suppressed, and deviation in the relative positions of the gratings 140, 150 and the detector 160 can be suppressed as far as possible. Therefore, it is possible to obtain a high-contrast X-ray image, even with a small X-ray dose.

This condition should be satisfied at least in respect of vibration in the direction orthogonal to the optical axis of the X-rays (the planar direction of the grating). This is because, as illustrated in FIG. 4A, vibration in the planar directions of the gratings 104, 105 and the detector 106 (x direction, y direction) has a great effect on the contrast of the X-ray image. Furthermore, when vibrations having various frequencies may be input from a vibration source, then the characteristics of the vibration-proof member should be determined on the basis of the frequency f₁ of the vibration having the greatest effect on the X-ray imaging (for example, the vibration having the highest rate of occurrence, or the vibration having the greatest amplitude, etc.).

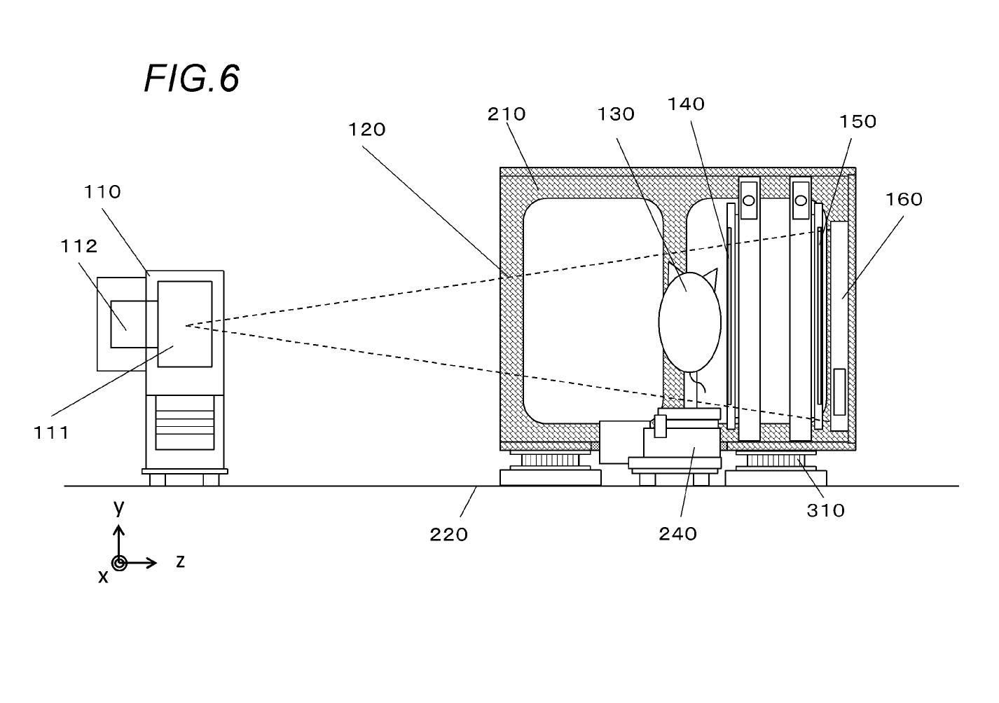

Next, a countermeasure for vibration produced by “(3) the object” will be explained. When the vibration produced by the object 130 cannot be ignored, then the transmission of this vibration to the gratings 140, 150 and the detector 160 must be suppressed. FIG. 6 is a modification example of an X-ray imaging apparatus having a configuration in which a support member which supports the gratings 140, 150 and the detector 160 is separate from a support member which supports the object 130. More specifically, an object stage 240 on which an object 130 is placed is disposed on top of the second support member 220, rather than the first support member 210. A first vibration-proof member 310 capable of suppressing vibration occurring in the object 130 is used between the first support member 210 and the second support member 220. The natural frequency f₀ of the first vibration-proof member 310 should be set so as to satisfy Formula (3), taking f₁ to be the frequency of the vibration produced by the object 130. Consequently, it is possible to suppress transmission, to the gratings 140, 150 and the detector 160, of the vibration in the object 130. If the transmission of the vibration of the object 130 to the X-ray generator 110 has an effect on imaging, then the vibration-proof member may be disposed at least between the object stage 240 and the second support member 220, and/or between the X-ray generator 110 and the second support member 220.

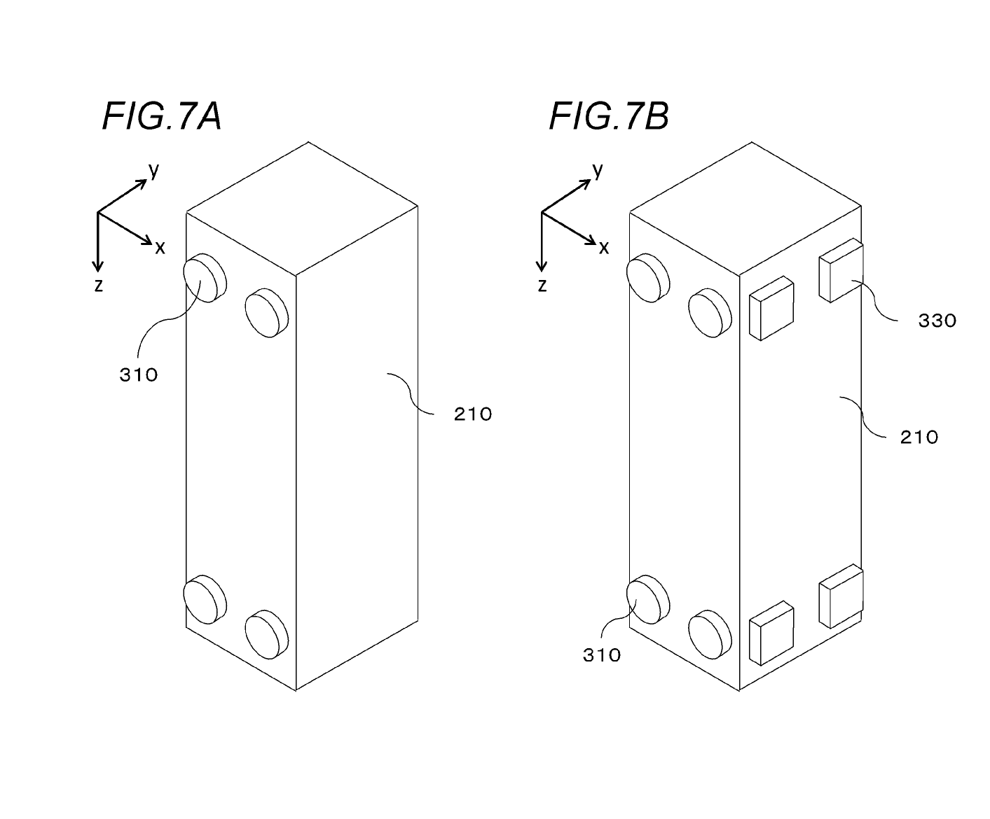

When the vibration transmission factor in the x direction and the vibration transmission factor in the y direction are different in the first vibration-proof member 310, then it may not be possible to adequately suppress the vibration in the two directions, x and y, simply by installing the vibration-proof member 310 of one type on the first support member 210, as shown in FIG. 1 and FIG. 7A. In this case, a third vibration-proof member 330 for suppressing vibration in a different direction to the first vibration-proof member 310 may be added. For instance, as shown in FIG. 7B, it is possible to provide a first vibration-proof member 310 which suppresses vibration in the x direction, on the zx surface of the first support member 210, and to provide a third vibration-proof member 330 which suppresses vibration in the y direction, on the xy surface of the first support member 210. Of course, it is also possible to adopt a configuration in which vibration-proof members 310, 330 of two types are installed on the same surface of the first support member 210. Similarly to the first vibration-proof member 310, the natural frequency of the third vibration-proof member 330 is set so as to be smaller than 2^{-1/2} times the frequency of the vibration that is to be suppressed.

The description given thus far has related to a vibration-proofing structure in which the gratings 140, 150 are two-dimensional gratings such as that shown in FIG. 2B. However, if the gratings 140, 150 are one-dimensional gratings such as that shown in FIG. 2A, then vibration needs to be prevented only in the periodic direction of the grating, and therefore a vibration-proof member capable of suppressing vibration in the same direction as the periodic direction of the grating should be provided. The amplitude permitted in the z direction (optical axis direction) is three or more differences in power greater than the amplitude permitted in the x direction and the y direction. Therefore, in general, the permitted vibration in the z direction is satisfied, when the vibration in the x direction and the y direction is prevented by using natural rubber and/or an air spring.

### First Embodiment

In the first embodiment, a more concrete embodiment of the X-ray imaging apparatus relating to the embodiment described above will be explained. In this embodiment, as shown in FIG. 1, an X-ray generation devices using a rotating anticathode 111 is employed as an X-ray generator 110. When the speed of rotation of the rotating anticathode 111 is 100 Hz and the axle 112 of the rotating anticathode is disposed in parallel with the z axis, then vibration of the same characteristics occurs respectively in the x direction and y direction. The gratings 140, 150 have a two-dimensional period in the x direction and the y direction, and the period of the first grating 140 is 6.1 μm, while the period of the second grating 150 is 8.2 μm. The rotating anticathode 111 generates a vibration of 100 Hz in the x direction and the y direction, and when the first vibration-proof member 310 is not present, the second grating 150 vibrates 4 μm in the x direction and the y direction.

When the first grating 140, the second grating 150 and the detector 160 are fixed to the first support member 210, and the vibration-proof member of Type 1 which has a transmission factor in the x direction and the y direction as shown in FIG. 5 is used for the first vibration-proof member 310, then it is possible to reduce the vibration of the second grating 150 to approximately 0.4 μm. Similarly, when the vibration-proof member of Type 2 which has the transmission factor in the x direction and the y direction as shown in FIG. 5 is used, then it is possible to reduce the transmission of the vibration of the installation environment, to the gratings.

When the first vibration-proof member 310 is not present, it is difficult to observe the moire fringe, but when the first vibration-proof member 310 is inserted, then the contrast is improved and it becomes possible to observe the moire fringe.

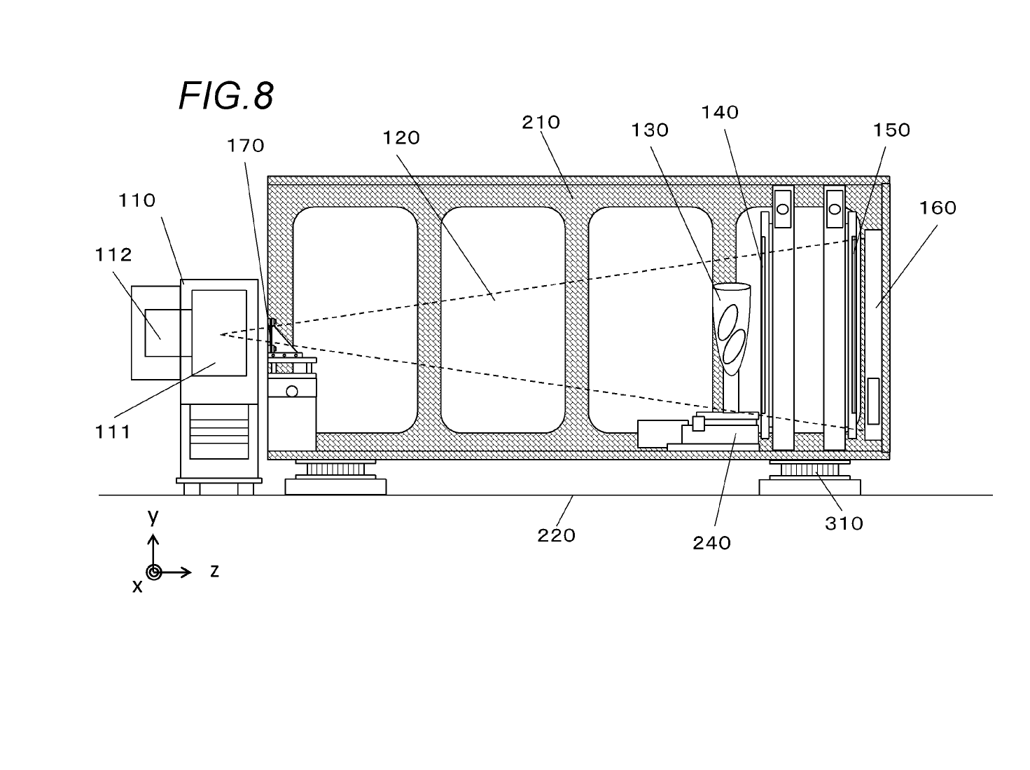

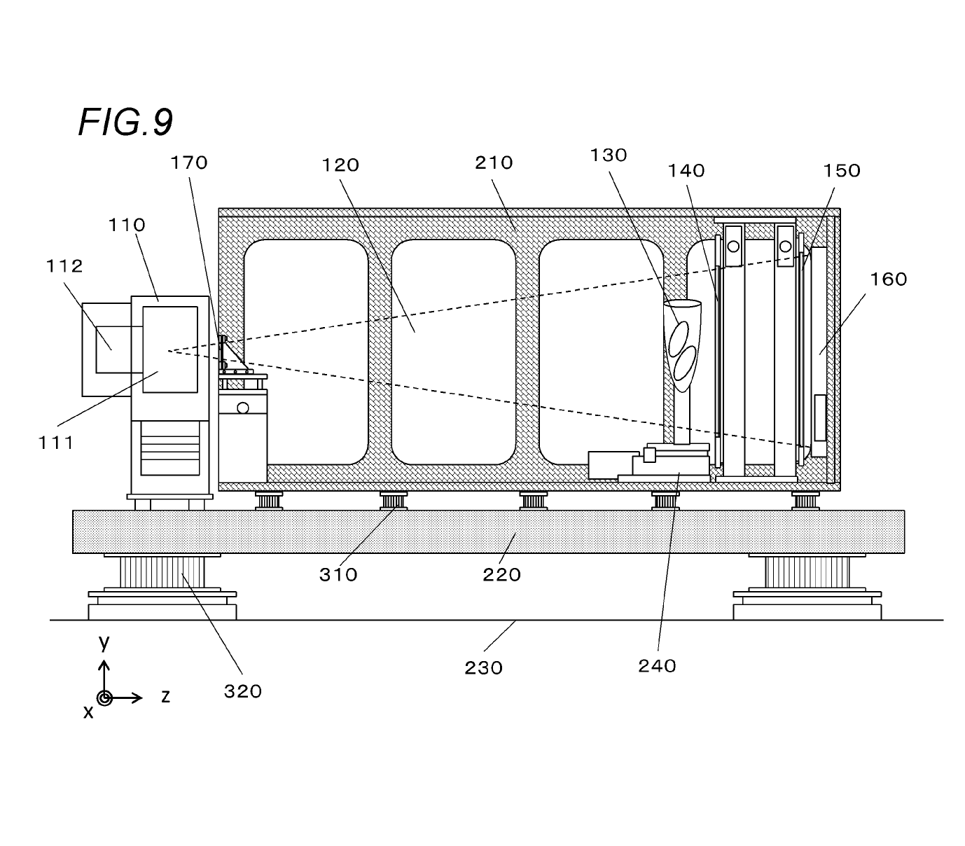

Furthermore, in order to raise the coherence of the X-rays 120 input to the first grating 140, a third grating 170 may be arranged between the X-ray generator 110 and the first grating 140, as shown in FIG. 8. The third grating 170 of this kind is called a “source grating”, and a Talbot interferometer of a type which uses a source grating is called a “Talbot-Lau interferometer”. In this configuration, the third grating 170 may be fixed to the first support member 210, similarly to the first grating 140 and/or the second grating 150. Therefore, since the relative positional relationship between the first to third gratings 140, 150, 170 and the detector 160 is fixed, it is possible to effectively suppress decline in the contrast of the X-ray image due to vibrations.

### Second Embodiment

When both the vibrations due to the X-ray generator 110 and the installation environment are to be prevented, the vibration-proof member of Type 2 such as that shown in FIG. 5 should be selected. However, since the vibration-proof member which has a low natural frequency is soft, then the movement of the first support member 210 may be greater than that of the second support member 220. This movement is caused by spontaneous loads produced by the operator or object, or changes in the amount of air in the air spring, etc., rather than vibrations which occur constantly in the X-ray generator 110, and the like. Due to this movement, when there is great variation in the relative positions of the X-ray generator 110 and the gratings and the detector 160 mounted on the first support member 210, then the information about the object 130 during image capture becomes blurred.

In the second embodiment, a case is described, with reference to FIG. 8, in which the relative positions of the X-ray generator 110 with respect to the gratings and the detector 160 during imaging of the object 130 change greatly depending on the focal size of the X-ray generator 110. The vibration-proof member of Type 1 such as that shown in FIG. 5 is not expected to provide an effect in suppressing vibration of the installation environment, but since the vibration-proof member is hard, then large movement does not occur during measurement of the object. On the other hand, the Type 2 vibration-proof member does have problems and effects such as that indicated previously. A configuration which combines vibration-proof members of a plurality of types having different vibration-proofing performance in this way, and simultaneously achieves a countermeasure against vibration of the X-ray generator 110 and vibration of the installation environment, as well as suppressing movement of the first support member 210, is described below.

The imaging apparatus according to the present embodiment includes a first support member 210 which supports the three gratings 170, 140, 150 and the detector 160, a second support member 220 which supports the X-ray generator 110 and the first support member 210, and a third support member 230 which supports the second support member 220. The third support member 230 may be the floor. A first vibration-proof member 310 is disposed between the first support member 210 and the second support member 220, and a second vibration-proof member 320 is disposed between the second support member 220 and the third support member 230. In this case, the first vibration-proof member 310 is desirably a vibration-proof member having vibration-proof performance such as that of Type 1 indicated in FIG. 5 (for example, a vibration-proof member capable of adequately suppressing vibrations caused by the X-ray generator 110). Furthermore, the second vibration-proof member 320 is desirably a vibration-proof member having a lower natural frequency than the first vibration-proof member 310, for example, a vibration-proof member such as Type 2 indicated in FIG. 5.

By means of the first support member 210 and the second support member 220, and the first vibration-proof member 310, it is possible to suppress transmission, to the gratings and the detector 160, of the vibrations produced by the X-ray generator 110 during imaging of the object 130. Furthermore, since the first vibration-proof member 310 is hard, then movement of the first support member 210 is suppressed, and deviation in the relative position of the X-ray generator 110 with respect to the gratings and the detector 160 can be suppressed to the focal size of the X-ray generator 110 or less.

On the other hand, the transmission of vibrations in the installation environment, to the gratings and the detector 160, is suppressed by the second support member 220, the third support member 230 and the second vibration-proof member 320. If the second support member 220 moves greatly during imaging of the object 130, then since the X-ray generator 110 and the first support member 210 are mounted on the second support member 220, then there is no great change in the relative position of the X-ray generator 110 with respect to the gratings and the detector 160.

According to the configuration of the present embodiment which has been described above, it is possible to provide vibration-proofing in respect of both vibrations from the X-ray generator 110 and vibrations from the installation environment, which have greatly different vibration frequencies, and furthermore, the movement of the first support member 210 which is caused by spontaneous loads, or the like, can also be suppressed. Consequently, greater robustness with respect to vibrations is achieved compared to the first embodiment, and an X-ray imaging apparatus capable of achieving X-ray images of higher quality can be obtained.

### Third Embodiment

Generally, vibration-proof members and dampers often have a cylindrical shape, and therefore the vibration transmission factor in the two axial directions in a particular plane is often different to the vibration transmission factor in the direction orthogonal to that plane. In the third embodiment, a vibration-proofing structure which is suitable for application to cases where the pitch of the gratings is the same in the x direction and the y direction will be described.

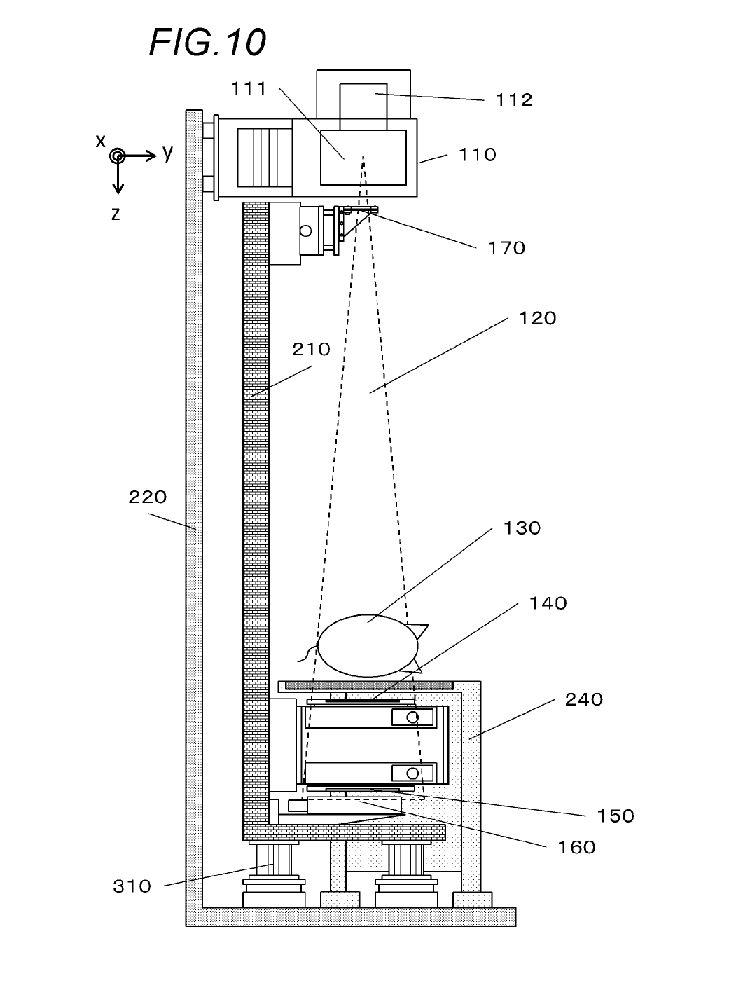

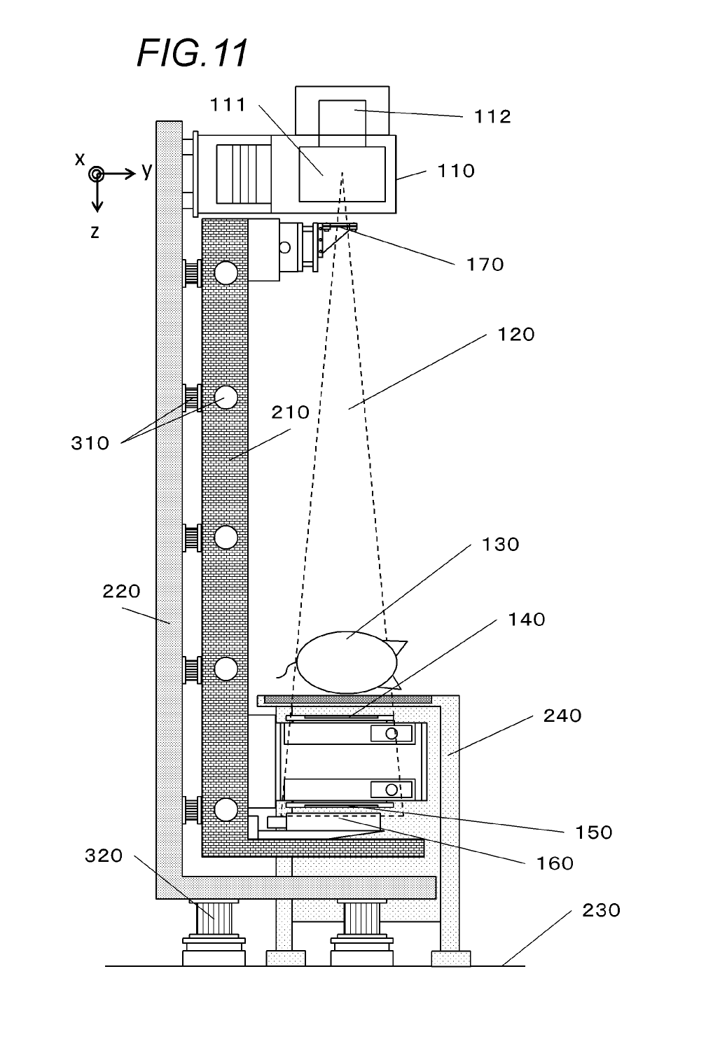

FIG. 10 shows an apparatus configuration according to the present embodiment. The apparatus of the present embodiment is installed in such a manner that gravity acts in the z direction (the direction parallel to the optical axis). A third grating 170, a first grating 140, a second grating 150 and a detector 160 are installed on a first support member 210, and the first support member 210 is installed on a second support member 220 via a first vibration-proof member 310. The first vibration-proof member 310 is a cylindrical-shaped vibration-proof member, and the height direction of the cylindrical shape (axis direction) is arranged so as to be parallel with the z direction. Therefore, since the vibration transmission factors relating to the periodic directions (x direction, y direction) of the gratings are the same, then a countermeasure against vibration in two directions can be achieved by material of one type, and hence the design costs and manufacturing costs are reduced. Furthermore, the first vibration-proof member 310 may be provided respectively in the x direction and the y direction, as shown in FIG. 11. In this case, desirably, the first vibration-proof members 310 are of the same material and shape and only differs in terms of their direction of arrangement. When the x-direction pitch and the y-direction pitch of the gratings are different, the characteristics of the first vibration-proof members 310 may be changed, between vibration-proofing in the x direction and vibration-proofing in the y direction.

In FIG. 10 and FIG. 11, the object 130 is fixed to the second support member 220 or the third support member 230 via the object stage 240, so as to prevent transmission of the vibration of the object 130, to the gratings and the detector 160. By arranging the object 130 as shown in FIG. 10 or FIG. 11, it is possible to supress the transmission, to the gratings or the detector 160, of vibration from the object 130, by the first vibration-proof member 310 or the second vibration-proof member 320.

### Fourth Embodiment

In the case of a one-dimensional grating, since the grating only has a pitch in the x direction, as shown in FIG. 2A, then the contrast of the moire fringe does not decline, even when there is vibration in the y direction. The permitted vibration in the z direction is three or more powers of difference greater than vibration in the x direction, similarly to the two-dimensional grating. Therefore, in a one-dimensional grating, a countermeasure against vibration is only needed in the periodic direction of the gratings (the x direction in the present example). The configuration of the apparatus is similar to the first embodiment and is therefore omitted here, but the contrast of the moire fringe can be maintained by taking into account only the vibration transmission factor in the x direction.

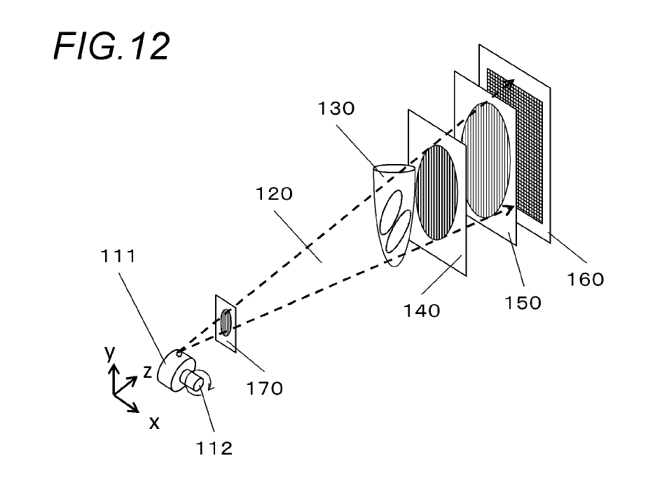

Furthermore, when a rotating anticathode 111 is used for the X-ray generator 110, as shown in FIG. 12, the directions of vibration of the X-ray generator 110 are the y direction and the z direction, since the axle 112 of the rotating anticathode is disposed in parallel to the periodic direction of the grating (in the present example, the x direction). Since the vibration occurring the x direction is reduced, then even if the X-ray generator 110 and the gratings and detector 160 are supported on the same support member, it is still possible to reduce vibration of the gratings and the detector 160 in the x direction. It is difficult to completely eliminate vibration in the x direction, even if the axle 112 of the rotating anticathode is provided in the x direction, but by combining use of a vibration-proof member, as in the first embodiment, the effect of reducing vibration in the x direction is further enhanced.

Even if the gratings are multi-dimensional gratings having two or more periodic directions (periodic structures), by providing the axle 112 of the rotating anticathode in a specific direction, it is possible to suppress decline in the contrast of the moire fringe in that specific direction. If the gratings are multi-dimensional gratings, then the axle 112 of the rotating anticathode may be provided so as to be parallel to the periodic direction having the narrowest pitch. For example, in a two-dimensional grating, if the pitch (or pattern) is different in the x direction and the y direction, then a direction of narrower pitch (or a direction of finer pattern) is more liable to produce a decline in the contrast of the moire fringe, than a direction of wider pitch (or a direction of coarser pattern). Therefore, by providing the axle 112 of the rotating anticathode in parallel with the periodic direction of narrow pitch, it is possible to reduce vibrations in a direction which is most liable to be affected by vibrations.

Above, desirable embodiments of the present invention have been described, but the present invention is not limited to these embodiments and may be modified or changed variously within the scope of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-177490, filed on Sep. 1, 2014, which is hereby incorporated by reference herein in its entirety.

What is claimed is:

1. An X-ray imaging apparatus, comprising:
a plurality of gratings;
a detector which detects X-rays that have been emitted from an X-ray generator and have been transmitted through the plurality of gratings;
a first support member which supports the plurality of gratings and the detector;
a second support member which supports the X-ray generator and the first support member; and
a first vibration-proof member which is disposed between the first support member and the second support member, wherein
a natural frequency of the first vibration-proof member in respect of at least vibration in a direction perpendicular to the optical axis of the X-rays is lower than 2^{-1/2} times the frequency of vibration generated by the X-ray generator.

2. The X-ray imaging apparatus according to claim 1, wherein
the second support member is installed on a third support member via a second vibration-proof member; and
a natural frequency of the second vibration-proof member in respect of at least vibration in a direction perpendicular to the optical axis of the X-rays is lower than the natural frequency of the first vibration-proof member.

3. The X-ray imaging apparatus according to claim 1, wherein a third vibration-proof member for suppressing vibration in a different direction to the first vibration-proof member is disposed between the first support member and the second support member.

4. The X-ray imaging apparatus according to claim 1, wherein a stage on which an object is placed is installed on the first support member.

5. The X-ray imaging apparatus according to claim 1, wherein a stage on which an object is placed is installed on the second support member.

6. The X-ray imaging apparatus according to claim 5, wherein a natural frequency of the first vibration-proof member in respect of at least vibration in a direction perpendicular to the optical axis of the X-rays is lower than 2^{-1/2} times the frequency of vibration generated by the object.

7. The X-ray imaging apparatus according to claim 2, wherein a stage on which an object is placed is installed on the third support member.

8. The X-ray imaging apparatus according to claim 1, wherein the plurality of gratings include a first grating, and a second grating disposed between the first grating and the detector.

9. The X-ray imaging apparatus according to claim 8, wherein
the first grating is a diffraction grating which forms a periodic pattern by diffracting X-rays; and
the second grating is an absorption grating which forms moire with the periodic pattern.

10. The X-ray imaging apparatus according to claim 8, wherein the plurality of gratings include a third grating disposed between the X-ray generator and the first grating.

11. The X-ray imaging apparatus according to claim 10, wherein the third grating is a source grating for raising coherence of X-rays which are incident on the first grating.

12. The X-ray imaging apparatus according to claim 1, wherein
the plurality of gratings are one-dimensional gratings;
the X-ray generator is an X-ray generator using a rotating anticathode; and
an axle of the rotating anticathode is disposed in parallel with the periodic directions of the plurality of gratings.

13. The X-ray imaging apparatus according to claim 1, wherein
the plurality of gratings are gratings having two or more periodic directions;
the X-ray generator is an X-ray generator using a rotating anticathode; and
an axle of the rotating anticathode is disposed in parallel with the periodic direction having the narrowest period, of the two or more periodic directions.
